(19) United States
(12) Patent Application Publication
(10) Pub. No.: US 2024/0377840 A1
(43) Pub. Date: Nov. 14, 2024

(54) AUTOMATIC GUIDED VEHICLE

(71) Applicant: Samsung Electronics Co., Ltd., Suwon-si (KR)

(72) Inventors: Daehyun Yoon, Suwon-si (KR); Jungjun Park, Suwon-si (KR); Jongbeom Park, Suwon-si (KR); Kongwoo Lee, Suwon-si (KR)

(21) Appl. No.: 18/640,395

(22) Filed: Apr. 19, 2024

(30) Foreign Application Priority Data
May 11, 2023 (KR) 10-2023-0060983
Jul. 4, 2023 (KR) 10-2023-0086393

(51) Int. Cl. G05D 1/656; G05D 105/20; G05D 107/70

(52) U.S. Cl. CPC G05D 1/656; G05D 2105/20; G05D 2107/70

(57) ABSTRACT

An automatic guided vehicle assembly includes a non-powered cart having a shelf unit configured to receive parts or tools, and an automated guided vehicle configured to attach and detach from the non-powered cart and configured to perform autonomous driving, wherein the automated guided vehicle includes a fastening pin configured to move upwardly and downwardly to attach to or detach the automated guided vehicle from the non-powered cart, wherein the non-powered cart includes a fastening unit configured to attach to and detach from the automated guided vehicle, and wherein the fastening unit includes a fastening member having a fastening guide configured to guide coupling of the fastening pinto the fastening unit.

### CROSS-REFERENCE TO RELATED APPLICATION(S)

This application claims benefit of priority to Korean Patent Application No. 10-2023-0086393 filed on Jul. 4, 2023, and Korean Patent Application No. 10-2023-0060983 filed on May 11, 2023, in the Korean Intellectual Property Office, the disclosures of which are incorporated herein by reference in their entirety.

### BACKGROUND

Example embodiments relate to an automatic guided vehicle.

Current factory systems have evolved into a flexible manufacturing system (FMS) and a flexible assembly system (FAS) in line with larger and more complex production environments.

In such factory automation, most devices have been automated and are unmanned, and an unmanned transport vehicle for automatic transportation of objects has been used. An automated guided vehicle (AGV), used for transporting goods in logistics systems and automation systems, is now an important element of factory systems.

An unmanned guided vehicle, which has been mainly used in an automated system, may be used as a means of transporting a non-powered cart loaded with parts and tools by automation.

However, docking between the automated guided vehicle and the non-powered cart may not be smoothly performed, such that the transfer time may increase, and docking of the automated guided vehicle and the non-powered cart may need to be performed by a worker.

### SUMMARY

An example embodiment is to provide an automatic guided vehicle which may smoothly dock with a non-powered cart.

According to an example embodiment, an automatic guided vehicle assembly includes a non-powered cart having a shelf unit configured to receive parts or tools, and an automated guided vehicle configured to attach to and detach from the non-powered cart and configured to perform autonomous driving, wherein the automated guided vehicle includes a fastening pin configured to move upwardly and downwardly to attach to or detach the automated guided vehicle from the non-powered cart, wherein the non-powered cart includes a fastening unit configured to attach to and detach from the automated guided vehicle, and wherein the fastening unit includes a fastening member having a fastening guide configured to guide coupling of the fastening pin.

According to some embodiments, an automatic guided vehicle assembly, comprising: a non-powered cart having a shelf unit configured to receive parts or tools; and an automated guided vehicle configured to attach to and detach from the non-powered cart and configured to perform autonomous driving, wherein the automated guided vehicle includes a fastening pin configured to move upwardly and downwardly to attach or detach the automated guided vehicle from the non-powered cart, wherein the non-powered cart includes a fastening unit configured to attach and detach from the automated guided vehicle, wherein the fastening pin of the automated guided vehicle is configured to be coupled to a fastening member in the fastening unit of the non-powered cart, wherein the fastening member includes a fastening base attached to the fastening unit, a pair of fastening guides on a front side of the fastening base and configured to slide, and a pair of elastic members each connected to one of the fastening guides, and wherein the automated guided vehicle includes a position adjustment member configured to adjust a position of the non-powered cart such that the fastening pin is coupled to the fastening member.

In some embodiments, an automatic guided vehicle assembly includes a non-powered cart having a shelf unit configured to receive parts or tools, and a fastening unit having a fastening member with a fastening base attached to the fastening unit, a pair of fastening guides on a front side of the fastening base and configured to slide, and a pair of elastic members each connected to one of the fastening guides, an automated guided vehicle configured to attach to and detach from the non-powered cart and configured to perform autonomous driving, the automated guided vehicle comprising: a fastening pin configured to move upwardly and downwardly to couple to the fastening member in the fastening unit of the non-powered cart; a position adjustment member having a connection terminal configured to transfer power or data communication to and from the non-powered cart, the position adjustment member configured to adjust a position of the non-powered cart such that the fastening pin is coupled to the fastening member; a main body with a sensor on a side surface of the main body; and a driving unit extending from the side surface of the main body, wherein the position adjustment member is configured to enter and exit the side surface of the main body.

### BRIEF DESCRIPTION OF DRAWINGS

The above and other aspects, features, and advantages in the example embodiment will be more clearly understood from the following detailed description, taken in combination with the accompanying drawings, in which:

FIG. 1 is a perspective diagram illustrating an automatic guided vehicle according to an example embodiment of the present disclosure;

FIG. 2 is a diagram illustrating an automated guided vehicle of an automatic guided vehicle according to an example embodiment of the present disclosure;

FIG. 3 is a diagram illustrating a non-powered cart of an automatic guided vehicle according to an example embodiment of the present disclosure;

FIGS. 4 to 7 are diagrams illustrating an operation of an automated guided vehicle of an automatic guided vehicle according to an example embodiment of the present disclosure;

FIGS. 8 to 11 are diagrams illustrating a method of coupling a fastening pin to a fastening member according to an example embodiment of the present disclosure; and

FIGS. 12 to 15 are diagrams illustrating a method of coupling a fastening pin to a fastening member when the fastening pin is not placed in a correct position according to an example embodiment of the present disclosure.

### DETAILED DESCRIPTION

Hereinafter, embodiments will be described as follows with reference to the accompanying drawings.

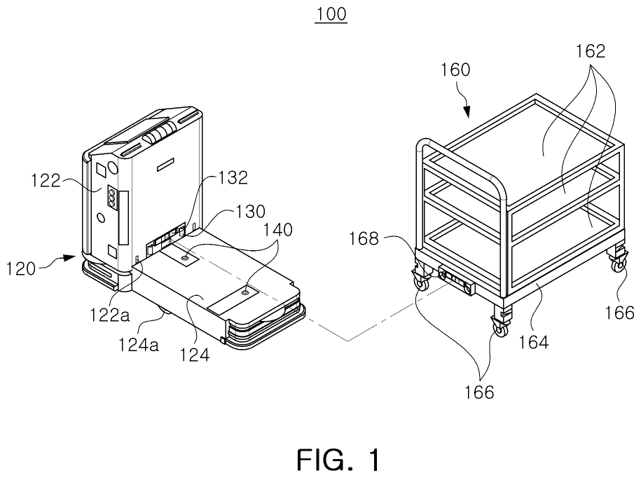

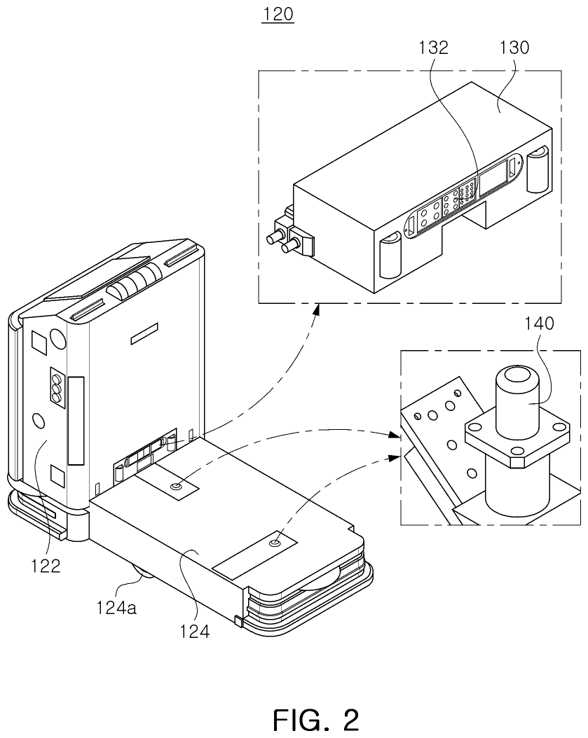

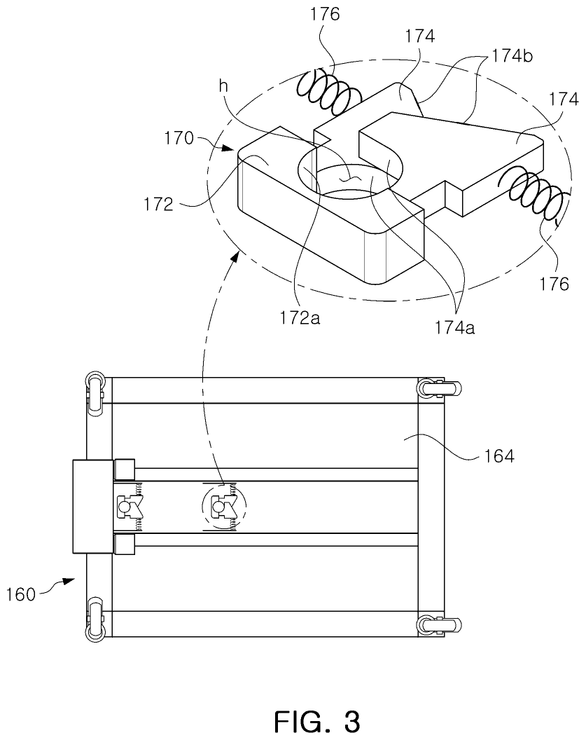

FIG. 1 is a perspective diagram illustrating an automatic guided vehicle assembly according to an example embodiment. FIG. 2 is a diagram illustrating an automated guided vehicle of an automatic guided vehicle assembly according to an example embodiment. FIG. 3 is a diagram illustrating a non-powered cart of an automatic guided vehicle assembly according to an example embodiment.

Referring to FIGS. 1 to 3, an automatic guided vehicle assembly 100 according to an example embodiment may include an automated guided vehicle 120 and a non-powered cart 160.

The automated guided vehicle 120 may transport the non-powered cart 160. As an example, the automated guided vehicle 120 may include a main body 122 and a driving unit 124 extending from one surface of the main body 122. A sensor 122a for sensing the position of the non-powered cart 160 may be provided on one surface of the main body 122. The sensor 122a may be connected to a control unit (not illustrated), and the control unit may move the automated guided vehicle 120 using information about the position of the non-powered cart 160 the sensor 122a. Also, an auxiliary wheel (122b, see FIG. 2) for driving the automated guided vehicle 120 may be provided in the main body 122. Also, a position adjustment member 130 for moving the non-powered cart 160 during docking of the automated guided vehicle 120 with the non-powered cart 160 may be provided on one surface of the main body 122. The position adjustment member 130 may slide to protrude from the main body 122 when moving the non-powered cart 160. To this end, the position adjustment member 130 may be connected to a sliding driving unit (not illustrated) such as an actuator. As an example, the position adjustment member 130 may include a connection terminal 132 configured to transfer power or data by a communication connection with the non-powered cart 160. The driving unit 124 may include a driving wheel 124a for moving the automated guided vehicle 120. The driving unit 124 may include a fastening pin 140 for docking with the non-powered cart 160. As an example, two fastening pins 140 may be spaced apart from each other, and when coupled to the non-powered cart 160, the fastening pin 140 may move upward and may protrude from an upper surface of the driving unit 124, and when detached or separated from the non-powered cart 160, the fastening pin 140 may move down and may be inserted into the internal space of the driving unit 124.

A detailed description of the operation of the position adjustment member 130 and the fastening pin 140 are described below.

The main body 122 of the automated guided vehicle 120 may include a control unit (not illustrated) connected to a sensor 122a and connected to a driving unit (not illustrated) for driving and controlling the driving wheel 124a of the driving unit 124.

The non-powered cart 160 may include a shelf unit 162 having a plurality of layers. The non-powered cart 160 may be configured to receive objects, such as parts and tools, which may be loaded on the shelf unit 162, for example, by automated loading techniques. Also, the non-powered cart 160 may include a fastening unit 164 to be coupled to the automated guided vehicle 120, and the fastening unit 164 may be placed below the shelf unit 162. The non-powered cart 160 may include a plurality of wheels 166 for driving. Also, as illustrated in FIG. 3, a fastening member 170 may be provided on the bottom surface of the fastening unit 164. The fastening member 170 may include a fastening base 172 in which a semicircular first fastening groove 172a is provided, a pair of fastening guides 174 on a front side of the fastening base 172 and having a second fastening groove 174a forming a circular fastening hole h together with the first fastening groove 172a, and a biasing member, such as a pair of opposing elastic members 176 for moving the fastening guide 174 to an original position thereof through restoring force when the fastening guide 174 slides. The elastic members 176 may be configured to move the fastening guide 174 to an original position through restoring force when the fastening guide 174 slides. Also, the fastening base 172 may be fixed or attached to the fastening unit 164. An inclined surface 174b may be provided on the fastening guide 174 such that the fastening guide 174 may move more smoothly when being in contact with the fastening pin 140. Also, one end of each of the elastic members 176 may be connected to one side of the fastening guide 174 and the other side may be connected to the fastening unit 164. Accordingly, the fastening guide 174 may be in contact with the fastening pin 140 and may be spaced apart from each other when the fastening pin 140 is inserted, and when the fastening pin 140 is inserted into the fastening hole h formed by the first fastening groove 172a and the second fastening groove 174a, the fastening guide 174 may return to an original position thereof by the restoring force of the elastic members 176. Thereafter, the fastening pin 140 may not move to the portion side on which the fastening guide 174 is positioned and may be coupled to the non-powered cart 160 while maintaining a position. As an example, the elastic members 176 may be configured as a biasing component such as a coil spring, but an example embodiment thereof is not limited thereto, and any component which may apply restoring force to the fastening guide 174 may be used as the elastic member 176.

The non-powered cart 160 may include a connection port 168 connected to a connection terminal 132 included in the automated guided vehicle 120. Accordingly, information about the non-powered cart 160 may be transmitted to the automated guided vehicle 120. Also, as the connection terminal 132 is coupled to the connection port 168, the non-powered cart 160 and the automated guided vehicle 120 may be physically attached or fastened to each other by the connection terminal 132 and the connection port 168 together with the physical fastening by the fastening pin 140 and the fastening member 170.

As described above, the time for correcting a position of the non-powered cart 160 may be reduced by moving the non-powered cart 160 using the position adjustment member 130 and fastening the fastening pin 140 to the fastening member 170, and docking of the automated guided vehicle 120 and the non-powered cart 160 may be performed smoothly.

Hereinafter, an operation of the automatic guided vehicle according to an example embodiment will be described with reference to the drawings.

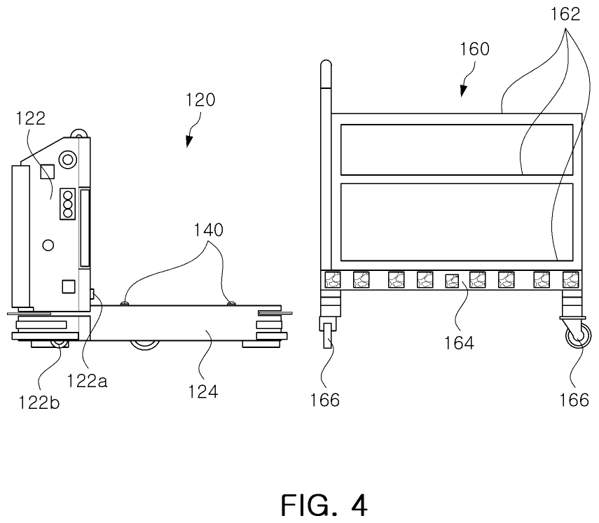

FIGS. 4 to 7 are diagrams illustrating an operation of an automated guided vehicle of an automatic guided vehicle assembly according to an example embodiment.

As illustrated in FIG. 4, when a command to move the non-powered cart 160 is transmitted to the automated guided vehicle 120 of the automatic guided vehicle assembly 100, the position of the non-powered cart 160 may be sensed by the sensor 122a as the automated guided vehicle 120 moves.

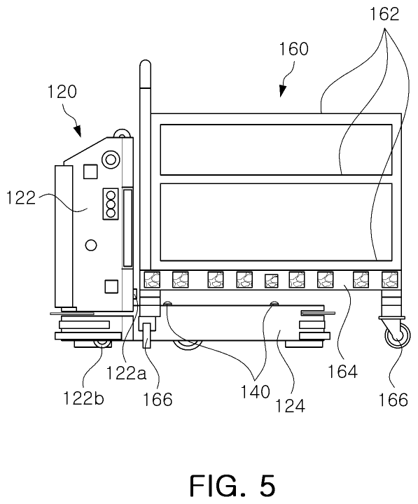

Thereafter, as illustrated in FIG. 5, the automated guided vehicle 120 may approach the non-powered cart 160, and the relative position of the driving unit 124 of the automated guided vehicle 120 and the automated guided vehicle 120 may be corrected by the sensor 122a in the automated guided vehicle 120. In this case, the driving unit 124 of the automated guided vehicle 120 may be inserted into a region below the fastening unit 164 of the non-powered cart 160.

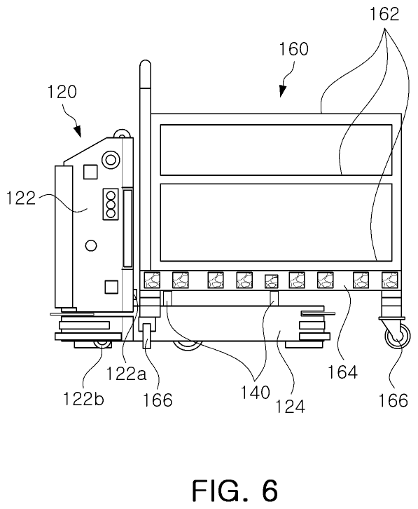

Thereafter, as illustrated in FIG. 6, the fastening pin 140 of the automated guided vehicle 120 may move up. In this case, the position of the fastening pin 140 may be identified by the sensor 122a. When the position of the fastening pin 140 is blocked by another obstacle and may not move up properly, the fastening pin 140 may approach the non-powered cart 160 and may return to the step of correcting the position of the automated guided vehicle 120 and may try redocking.

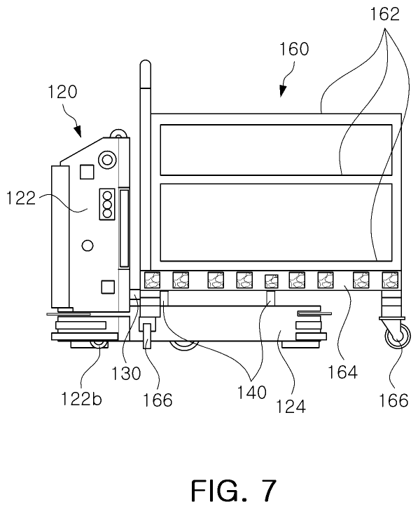

Thereafter, as illustrated in FIG. 7, the position adjustment member 130 of the automated guided vehicle 120 may move the non-powered cart 160 to the opposite side of the main body 122 while sliding to the non-powered cart 160 side. Accordingly, the fastening pin 140 may be fastened to the fastening member 170 as described below.

Hereinafter, a method of combining a fastening pin and a fastening member will be described with reference to the drawings.

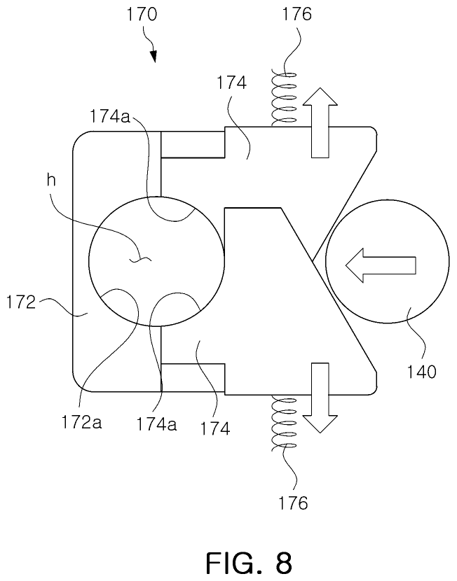

FIGS. 8 to 11 are diagrams illustrating a method of coupling a fastening pin to a fastening member according to an example embodiment.

As illustrated in FIG. 6, when the fastening pin 140 moves up, the fastening pin 140 and the fastening member 170 may be configured as illustrated in FIG. 8.

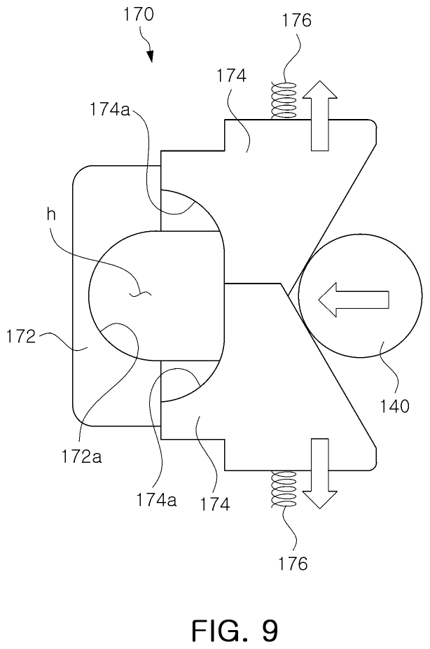

Thereafter, as illustrated in FIG. 7, when the position adjustment member 130 of the automated guided vehicle 120 slides toward the non-powered cart 160 and moves the non-powered cart 160 to the opposite side of the main body 122, as illustrated in FIG. 9, the positions of the fastening member 170 and the fastening pin 140 may become closer.

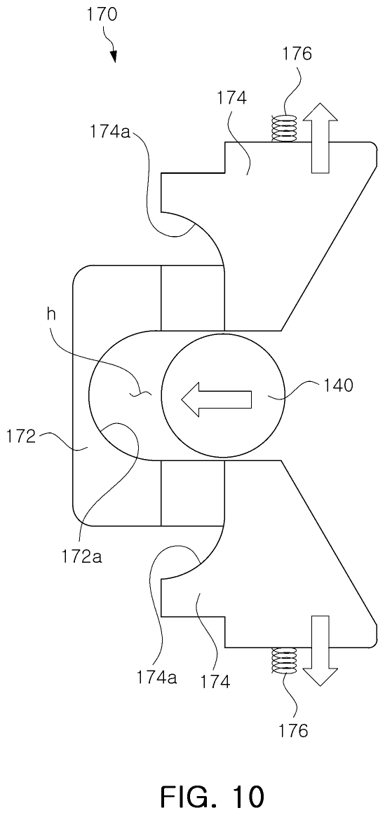

Thereafter, when the position adjustment member 130 moves the non-powered cart 160 further to the opposite side of the main body 122 while sliding to the side of the non-powered cart 160, as illustrated in FIG. 10, the fastening pin 140 may be in contact with the inclined surface 174b included in the fastening guide 174 of the fastening member 170.

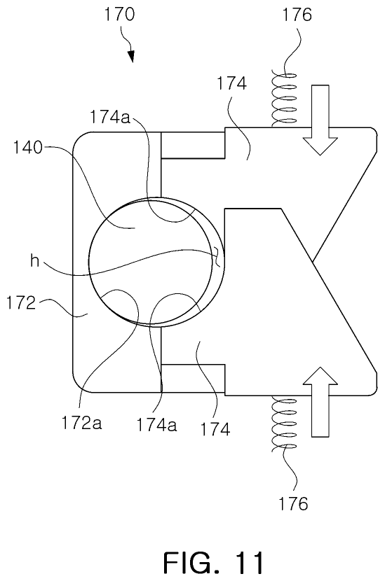

Thereafter, when the position adjustment member 130 moves the non-powered cart 160 further to the opposite side of the main body 122, as illustrated in FIG. 11, the fastening pin 140 moves the fastening guides 174 of the fastening member 170 to both sides to be spaced apart from each other.

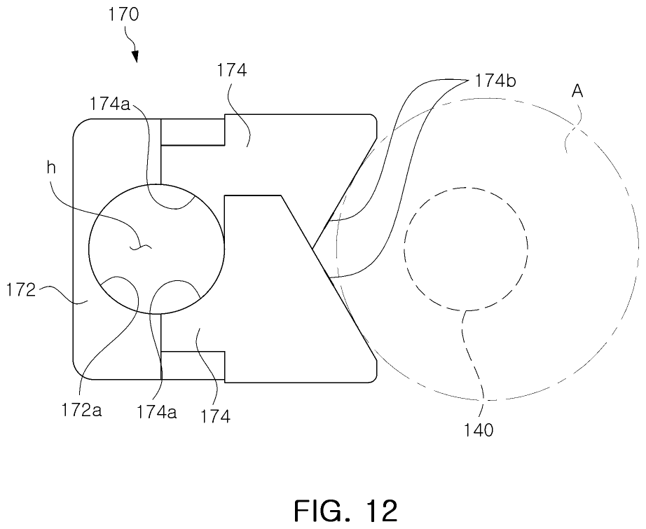

Thereafter, when the position adjustment member 130 moves the non-powered cart 160 further to the opposite side of the main body 122, as illustrated in FIG. 12, the fastening pin 140 may be inserted into the fastening hole h formed by the first fastening groove 172a and the second fastening groove 174a. In this case, the fastening guide 174 of the fastening member 170 may return to an original position thereof by the elastic member 176. Accordingly, as the fastening pin 140 moves in the opposite direction to the inserted direction, the fastening pin 140 may be prevented from being separated from the fastening hole h.

Meanwhile, in the following, a fastening method of the fastening pin 140 and the fastening member 170 when the fastening pin 140 is not placed in a correct position will be described.

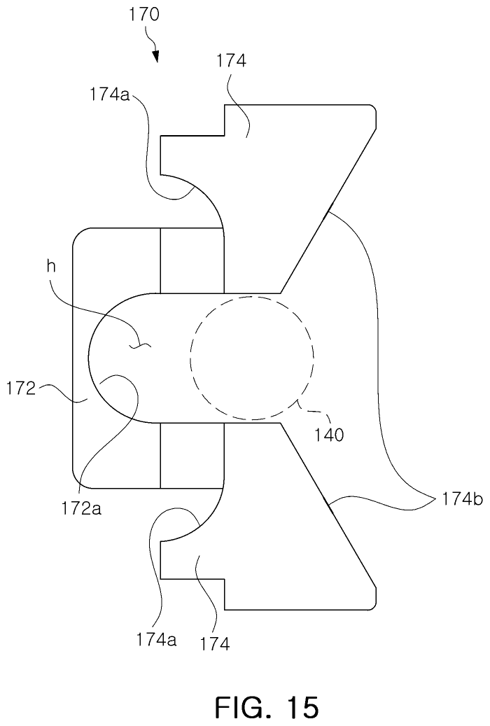

FIGS. 12 to 15 are diagrams illustrating a method of coupling a fastening pin to a fastening member when the fastening pin is not placed in a correct position according to an example embodiment.

First, as illustrated in FIG. 12, the error-probable position region A of the fastening pin 140 may be formed in a circular shape. Meanwhile, when the fastening pin 140 is placed in an error-probable position region A, the fastening pin 140 may be coupled into the fastening hole h formed by the first fastening groove 172a and the second fastening groove 174a of the fastening member 170.

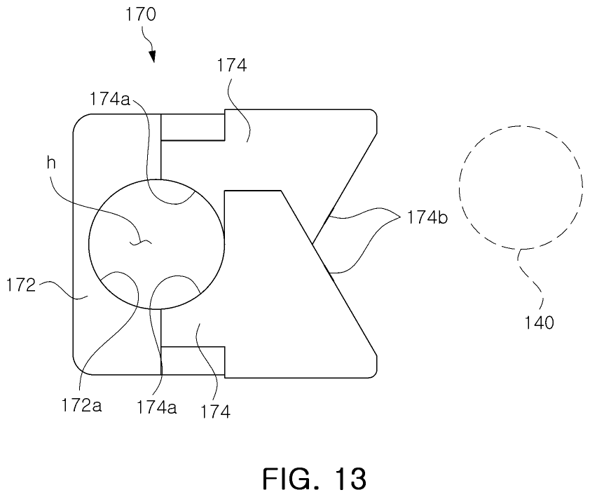

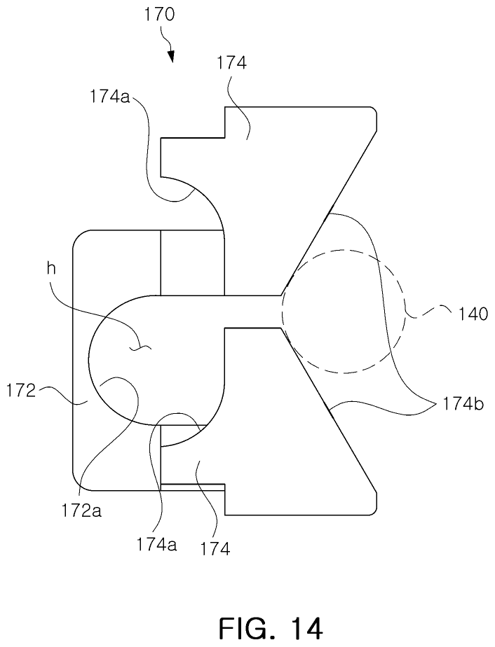

Specifically, as illustrated in FIG. 12, even when the fastening pin 140 is displaced from the fastening hole h in the error-probable position region A illustrated in FIG. 11, as illustrated in FIG. 13, when the non-powered cart 160 moves, the fastening pin 140 may be in contact with the inclined surface 174b of the fastening guide 174. Thereafter, the fastening guides 174 may move to be spaced apart from each other by the fastening pin 140. Thereafter, as illustrated in FIG. 14, the fastening pin 140 may be inserted into the fastening hole h of the fastening member 170.

When the fastening pin 140 is placed in the error-probable position region A as described above, the fastening pin 140 may be coupled into the fastening hole h formed by the first fastening groove 172a and the second fastening groove 174a of the fastening member 170.

According to the aforementioned example embodiments, the automated guided vehicle which may smoothly dock with the non-powered cart may be provided.

While the example embodiments have been illustrated and described above, it will be configured as apparent to those skilled in the art that modifications and variations may be made without departing from the scope in the example embodiment as defined by the appended claims.

What is claimed is:

1. An automatic guided vehicle assembly, comprising:
a non-powered cart having a shelf unit configured to receive parts or tools; and
an automated guided vehicle configured to attach to and detach from the non-powered cart and further configured to perform autonomous driving,
wherein the automated guided vehicle includes a fastening pin configured to move upwardly and downwardly to attach or detach the automated guided vehicle from the non-powered cart,
wherein the non-powered cart includes a fastening unit with a fastening member having a fastening guide configured to guide coupling of the fastening pin to attach or detach the automated guided vehicle from the non-powered cart.

2. The automatic guided vehicle assembly of claim 1, wherein the fastening member includes a fastening base attached to the fastening unit, a pair of fastening guides on a front side of the fastening base, and a pair of elastic members each connected to one of the fastening guides.

3. The automatic guided vehicle assembly of claim 2,
wherein the fastening base includes a semicircular first fastening groove, and
wherein the fastening guide includes a second fastening groove configured to form a fastening hole together with the semicircular first fastening groove.

4. The automatic guided vehicle assembly of claim 3, wherein the fastening guide includes an inclined surface configured to guide movement of the fastening pin.

5. The automatic guided vehicle assembly of claim 1, wherein the automated guided vehicle includes a main body and a driving unit extending from one surface of the main body.

6. The automatic guided vehicle assembly of claim 5, wherein the driving unit is inserted below the fastening unit when the automated guided vehicle is coupled to the non-powered cart.

7. The automatic guided vehicle assembly of claim 5, wherein the driving unit is on a side of the main body, and the main body includes a sensor on a surface of the side of the main body on which the driving unit is positioned.

8. The automatic guided vehicle assembly of claim 7, wherein the main body includes a position adjustment member configured to enter and exit the surface on which the sensor is positioned.

9. The automatic guided vehicle assembly of claim 8, wherein the position adjustment member includes a connection terminal connected to a connection port in the non-powered cart.

10. The automatic guided vehicle assembly of claim 5, wherein the fastening pin is configured to enter and exit from an upper surface of the driving unit.

11. The automatic guided vehicle assembly of claim 10, wherein a plurality of the fastening pins are spaced apart from each other.

12. The automatic guided vehicle assembly of claim 5, wherein the driving unit includes a driving wheel configured to move the automated guided vehicle.

13. The automatic guided vehicle assembly of claim 1, wherein the non-powered cart includes a plurality of wheels configured to move the non-powered cart.

14. An automatic guided vehicle assembly, comprising:
a non-powered cart having a shelf unit configured to receive parts or tools; and
an automated guided vehicle configured to attach to and detach from the non-powered cart and configured to perform autonomous driving,
wherein the automated guided vehicle includes a fastening pin configured to move upwardly and downwardly to attach or detach the automated guided vehicle from the non-powered cart,
wherein the non-powered cart includes a fastening unit configured to attach and detach from the automated guided vehicle,
wherein the fastening pin of the automated guided vehicle is configured to be coupled to a fastening member in the fastening unit of the non-powered cart,
wherein the fastening member includes a fastening base attached to the fastening unit, a pair of fastening guides on a front side of the fastening base and configured to slide, and a pair of elastic members each connected to one of the fastening guides, and
wherein the automated guided vehicle includes a position adjustment member configured to adjust a position of the non-powered cart such that the fastening pin is coupled to the fastening member.

15. The automatic guided vehicle assembly of claim 14, wherein the pair of fastening guides each include an inclined surface configured to guide movement of the fastening pin.

16. The automatic guided vehicle assembly of claim 14,
wherein the fastening base includes a semicircular first fastening groove, and
wherein each of the pair of fastening guides includes a second fastening groove configured to form a fastening hole together with the first semicircular fastening groove.

17. The automatic guided vehicle assembly of claim 14, wherein the automated guided vehicle includes a main body and a driving unit extending from one surface of the main body.

18. The automatic guided vehicle assembly of claim 17, wherein the main body includes a sensor on the one surface of the main body and positioned on a side of the main body on which the driving unit is positioned.

19. The automatic guided vehicle assembly of claim 18, wherein the position adjustment member is configured to enter and exit one surface of the main body on which the sensor of the main body is positioned.

20. An automatic guided vehicle assembly, comprising:
a non-powered cart having a shelf unit configured to receive parts or tools, and a fastening unit having a fastening member with a fastening base attached to the fastening unit, a pair of fastening guides on a front side of the fastening base and configured to slide, and a pair of elastic members each connected to one of the fastening guides,
an automated guided vehicle configured to attach to and detach from the non-powered cart and configured to perform autonomous driving, the automated guided vehicle comprising:
a fastening pin configured to move upwardly and downwardly to couple to the fastening member in the fastening unit of the non-powered cart;
a position adjustment member having a connection terminal configured to transfer power or data communication to and from the non-powered cart, the position adjustment member configured to adjust a position of the non-powered cart such that the fastening pin is coupled to the fastening member;
a main body with a sensor on a side surface of the main body; and
a driving unit extending from the side surface of the main body, wherein the position adjustment member is configured to enter and exit the side surface of the main body.
